(19) United States
(12) Patent Application Publication
(10) Pub. No.: US 2026/0201799 A1
(43) Pub. Date: Jul. 16, 2026

(54) SYSTEMS AND METHODS FOR MINIMIZING EFFECTS OF NEAR-WELLBORE STRESSES AND STRESS VARIATIONS ON FORMATION ROCK IN-SITU STRESS TESTING

(71) Applicant: Schlumberger Technology Corporation, Sugar Land, TX (US)

(72) Inventors: Vladislav ACHOUROV, Stavanger (NO); Adriaan GISOLF, Bucharest (RO); Harish DATIR, Stavanger (NO)

(21) Appl. No.: 19/136,874

(22) PCT Filed: Dec. 18, 2023
(86) PCT No.: PCT/US2023/084561

§ 371 Date: Jun. 7, 2025

Related U.S. Application Data
(60) Provisional application No. 63/387,746, filed on Dec. 16, 2022.

(51) Int. Cl. E21B 49/00; E21B 33/12; E21B 47/002; G01V 1/50

(52) U.S. Cl. CPC E21B 49/008; E21B 47/0025; G01V 1/50; E21B 33/12; G01V 2210/74

(57) ABSTRACT

Systems and methods presented herein provide for minimization of effects of near-wellbore stresses and stress variations during in-situ stress testing of formation rock by, for example, setting upper and lower packers of an in-situ stress testing tool at a target depth within a wellbore traversing a subterranean formation, injecting fluid from the in-situ stress testing tool into the subterranean formation at a downhole location within a first interval between the upper and lower packers to create and/or propagate a fracture within the subterranean formation, iteratively conducting a plurality of cycles of potential closure and/or re-opening of the fracture while injecting the fluid from the in-situ stress testing tool into the subterranean formation and recording the minimum stress measurements of the subterranean formation, and moving the upper and lower packers of the in-situ stress testing tool to a new depth within the wellbore while running an imaging and/or acoustic tool module of the in-situ stress testing tool to locate the fracture near a middle of a second interval between the upper and lower packers.

### CROSS-REFERENCE TO RELATED APPLICATIONS

The present application is an International Application that claims priority to U.S Provisional Patent Application No. 63/387,746 that was filed on Dec. 16, 2022, which is herein incorporated by reference in its entirety.

### FIELD

The present disclosure generally relates to systems and methods for minimizing effects of near-wellbore stresses and stress variations during in-situ stress testing of formation rock.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Downhole acquisition tools are used to extract quantitative information of formation rock stresses during certain drilling operations. The formation rock stress information may facilitate predicting geo-mechanical problems that may be associated with a wellbore of interest. For example, vertical stress, minimum horizontal stress, maximum horizontal stress, and azimuth of minimum horizontal stress are geo-stresses that may be used to characterize formation rock stress. These stress parameters may be estimated using various techniques. For example, vertical stress may be estimated from an integral of a density log obtained using the downhole acquisition tool. Minimum horizontal stress may be estimated using fracturing techniques and/or leak-off data, and its direction from borehole caliper or image analysis. During formation testing to estimate the minimum horizontal stress of the formation rock, the downhole acquisition tool injects a fluid into the formation to create a fracture. In particular, the downhole acquisition tool pumps a fluid into the formation, thereby causing a local increase in pressure at the injection site. The pressure continues to buildup until the formation rock mechanically fails and fractures. In certain instances, existing formation rock fractures may be reopened by injecting the fluid into the existing fractures. Following fracture, the injected fluid exits the fracture and a closure event (e.g., closing of the fracture) occurs. The minimum horizontal stress of the formation rock may be determined based on fracture closure pressure (e.g., the amount of pressure observed when the fracture closed).

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that includes setting upper and lower packers of an in-situ stress testing tool at a target depth within a wellbore traversing a subterranean formation. The method also includes injecting fluid from the in-situ stress testing tool into the subterranean formation at a downhole location within a first interval between the upper and lower packers to create and/or propagate a fracture within the subterranean formation. The method further includes recording minimum stress measurements of the subterranean formation while injecting the fluid from the in-situ stress testing tool into the subterranean formation. In addition, the method includes iteratively conducting a plurality of cycles of potential closure and/or re-opening of the fracture while injecting the fluid from the in-situ stress testing tool into the subterranean formation and recording the minimum stress measurements of the subterranean formation. The method also includes moving the upper and lower packers of the in-situ stress testing tool to a new depth within the wellbore while running an imaging and/or acoustic tool module of the in-situ stress testing tool to locate the fracture near a middle of a second interval between the upper and lower packers.

Certain embodiments of the present disclosure also include a formation testing system that includes an in-situ stress testing tool having upper and lower packers. The formation testing system also includes a control system configured to control operations of the in-situ stress testing tool. The operations of the in-situ stress testing tool include setting the upper and lower packers at a target depth within a wellbore traversing a subterranean formation. The operations of the in-situ stress testing tool also include injecting fluid into the subterranean formation at a downhole location within a first interval between the upper and lower packers to create and/or propagate a fracture within the subterranean formation. The operations of the in-situ stress testing tool further include recording minimum stress measurements of the subterranean formation while injecting the fluid into the subterranean formation. In addition, the operations of the in-situ stress testing tool include iteratively conducting a plurality of cycles of potential closure and/or re-opening of the fracture while injecting the fluid into the subterranean formation and recording the minimum stress measurements of the subterranean formation. The operations of the in-situ stress testing tool also include moving the upper and lower packers of the in-situ stress testing tool to a new depth within the wellbore while locating the fracture near a middle of a second interval between the upper and lower packers.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 illustrates an in-situ stress testing tool being suspended in a wellbore traversing a formation by a cable, in accordance with embodiments of the present disclosure;

FIG. 2 illustrates an example imaging and/or acoustic tool module, which may be used as part of the in-situ stress testing tool of FIG. 1, in accordance with embodiments of the present disclosure;

FIG. 3 illustrates a surface control system that may control the oil and gas well system of FIG. 1, in accordance with embodiments of the present disclosure;

FIG. 4 illustrates an embodiment of a tool control system illustrated in FIG. 1, in accordance with embodiments of the present disclosure;

FIG. 5 illustrates the in-situ stress testing tool of FIG. 1 using a dual packer system to isolate an interval of the wellbore and creating a fracture in the formation, in accordance with embodiments of the present disclosure; and

FIG. 6 illustrates an example workflow to enable representative fracture closure measurements utilizing the in-situ stress testing tool of FIG. 1, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequently, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention).

It has been observed in many formation rock in-situ stress testing (e.g., micro-fracturing) jobs that it can be very challenging to obtain a representative closure pressure after a fracture has been created. Several techniques exist to close fractures and contain fracture closure pressure. The embodiments described herein provide for a workflow that enables fracture closure measurements for scenarios where past techniques struggle or fail to measure closure pressure.

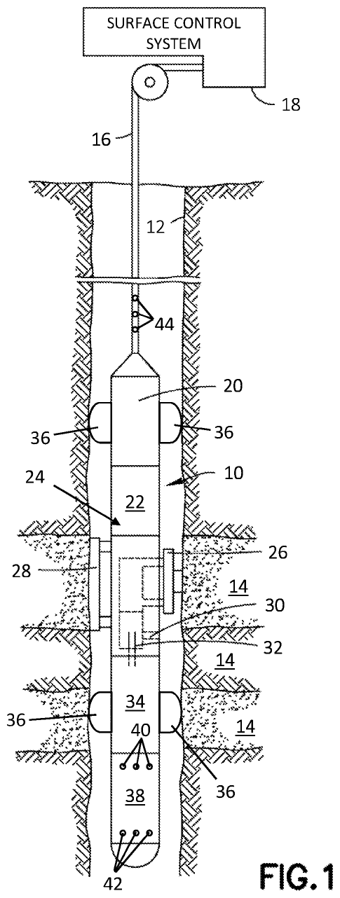

FIG. 1 illustrates an in-situ stress testing tool 10 being suspended in a wellbore 12 traversing a subterranean formation 14 by a cable 16 that is spooled in a usual fashion on a suitable winch (not shown) on the formation surface. On the surface, the cable 16 may be electrically coupled to a surface control system 18 that is configured to at least partially control operation of the in-situ stress testing tool 10 by communicating data and control signals to and from the in-situ stress testing tool 10 via the cable 16, as described in greater detail herein. Although described primarily herein as using a cable 16 (e.g., wireline cable) to convey the in-situ stress testing tool 10 into the wellbore 12, in other embodiments, other types of tool conveyance systems may be used to convey the in-situ stress testing tool 10 into the wellbore 12, such as coiled tubing, pipe conveyance, and so forth. As illustrated, in certain embodiments, the in-situ stress testing tool 10 includes an elongated body 20 that encloses a tool control system 22 that is configured to communicate with the surface control system 18 for the purpose of controlling operation of the in-situ stress testing tool 10, as described in greater detail herein.

In particular, as described in greater detail herein, the in-situ stress testing tool 10 may include a formation testing tool module 24 that includes a fluid admitting assembly 26 and a tool anchoring member 28, which may be arranged on opposite lateral sides of the body 20. In certain embodiments, the fluid admitting assembly 26 may be configured to selectively seal off or isolate selected portions of the wall of the wellbore 12 such that pressure or fluid communication with the adjacent formation 14 is established. In addition, in certain embodiments, the formation testing tool module 24 of the in-situ stress testing tool 10 may include a fluid analysis module 30 with a flow line 32 through which fluid collected from the formation 14 flows. The fluid may thereafter be expelled through a port (not shown) or may be directed to one or more fluid collecting chambers 34 of the formation testing tool module 24, which may receive and retain the fluids collected from the formation 14 or wellbore 12. As described in greater detail herein, the fluid admitting assembly 26, the fluid analysis module 30, and the flow path to the fluid collecting chambers 34 of the formation testing tool module 24 may be controlled by the control systems 18, 22.

In addition, in certain embodiments, the in-situ stress testing tool 10 may be associated with one or more inflatable packers 36 that are configured to inflate against the wellbore 12 to, for example, provide a seal between the inflatable packers 36 and the wellbore 12. In addition, in certain embodiments, the one or more inflatable packers 36 may isolate portions of the wellbore 12 to facilitate the collection of fluids via the in-situ stress testing tool 10. Although illustrated in FIG. 1 as including an in-situ stress testing tool 10 held in place within the wellbore 12 by one or more inflatable packers 36, in other embodiments, one or more inflatable packers 36 may isolate other types of downhole tools (e.g., other types of formation testing tools, imaging/acoustic tools, and so forth) within the wellbore 12.

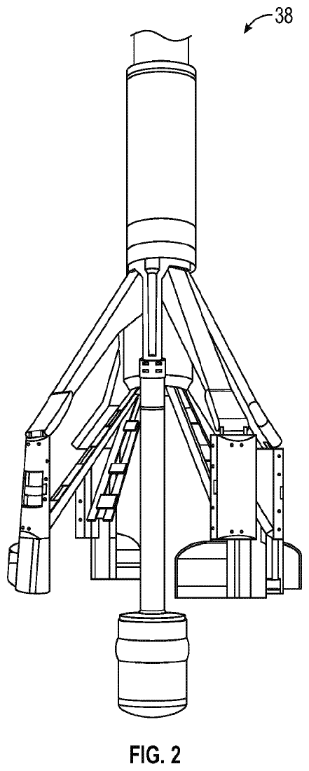

Furthermore, as described in greater detail herein, in certain embodiments, the in-situ stress testing tool 10 may include an imaging and/or acoustic tool module 38, which may be used in combination with the formation testing tool module 24 to form an in-situ stress testing tool 10 that combines formation testing capabilities with imaging and/or acoustic imaging capabilities, as described in greater detail herein. For example, in certain embodiments, the imaging and/or acoustic tool module 38 may include one or more transmitters 40 that may be configured to generate waves that may be detected by one or more receivers 42 of the imaging and/or acoustic tool module 38 itself and/or one or more receivers 44 that are disposed on the cable 16, are part of the cable 16, or are disposed elsewhere on the in-situ stress testing tool 10. In general, the generated waves may be detected by the receivers 42, 44 for the purpose of characterizing the formation 14, as described in greater detail herein. FIG. 2 illustrates an example imaging and/or acoustic tool module 38, which may be used as part of the in-situ stress testing tool 10, as described in greater detail herein.

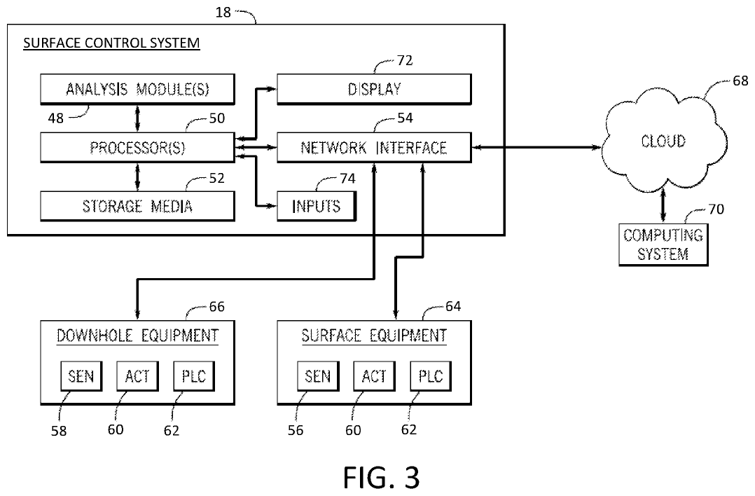

FIG. 3 illustrates an embodiment of the surface control system 18 illustrated in FIG. 1. In certain embodiments, the surface control system 18 may include one or more analysis modules 48 (e.g., a program of processor executable instructions and associated data) that may be configured to perform various functions of the embodiments described herein. In certain embodiments, to perform these various functions, an analysis module 48 executes on one or more processors 50 of the surface control system 18, which may be connected to one or more storage media 52 of the surface control system 18. Indeed, in certain embodiments, the one or more analysis modules 48 may be stored in the one or more storage media 52.

In certain embodiments, the one or more processors 50 may include a microprocessor, a microcontroller, a processor module or subsystem, a programmable integrated circuit, a programmable gate array, a digital signal processor (DSP), or another control or computing device. In certain embodiments, the one or more storage media 52 may be implemented as one or more non-transitory computer-readable or machine-readable storage media. In addition, in certain embodiments, the one or more storage media 52 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the processor-executable instructions and associated data of the analysis module(s) 48 may be provided on one computer-readable or machine-readable storage medium of the storage media 52 or, alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 52 may be located either in the machine running the machine-readable instructions, or may be located at a remote site from which machine-readable instructions may be downloaded over a network for execution.

In certain embodiments, the processor(s) 50 may be connected to a network interface 54 of the surface control system 18 to allow the surface control system 18 to communicate with various surface sensors 56 and/or downhole sensors 58 described herein, as well as communicate with various actuators 60 and/or PLCs 62 of surface equipment 64 (e.g., surface pumps, valves, and so forth) and/or of downhole equipment 66 (e.g., the formation testing tool module 24 of the in-situ stress testing tool 10, the imaging and/or acoustic tool module 38 of the in-situ stress testing tool 10, the inflatable packers 36, electric submersible pumps, other downhole tools, and so forth) for the purpose of controlling operation of the oil and gas well system illustrated in FIG. 1. In certain embodiments, the network interface 54 may also facilitate the surface control system 18 to communicate data to a cloud-based service 68 (or other wired and/or wireless communication network) to, for example, archive the data or to enable external computing systems 70 (e.g., cloud-based computing systems, in certain embodiments) to access the data and/or to remotely interact with the surface control system 18. For example, in certain embodiments, some or all of the analysis modules 48 described in greater detail herein may be executed via cloud and edge deployments.

In certain embodiments, the surface control system 18 may include a display 72 configured to display a graphical user interface to present results of the operations described herein. In addition, in certain embodiments, the graphical user interface may present other information to operators of the equipment 64, 66 described herein. For example, the graphical user interface may include a dashboard configured to present visual information to the operators. In certain embodiments, the dashboard may show live (e.g., real-time) data as well as the results of the operations described herein.

In addition, in certain embodiments, the surface control system 18 may include one or more input devices 74 configured to enable operators to, for example, provide commands to the equipment 64, 66 described herein. For example, in certain embodiments, the in-situ stress testing tool 10 may provide information to the operators regarding the formation testing operations, and the operators may implement actions relating to the formation testing operations by manipulating the one or more input devices 74, as described in greater detail herein. In certain embodiments, the display 72 may include a touch screen interface configured to receive inputs from operators. For example, an operator may directly provide instructions to the in-situ stress testing tool 10 via the user interface, and the instructions may be output to the in-situ stress testing tool 10 via a controller and a communication system of the in-situ stress testing tool 10.

It should be appreciated that the surface control system 18 illustrated in FIG. 3 is only one example of a well control system, and that the surface control system 18 may have more or fewer components than shown, may combine additional components not depicted in the embodiment of FIG. 3, and/or the surface control system 18 may have a different configuration or arrangement of the components depicted in FIG. 3. In addition, the various components illustrated in FIG. 3 may be implemented in hardware, software, or a combination of both hardware and software, including one or more signal processing and/or application specific integrated circuits. Furthermore, the operations of the surface control system 18 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

In addition, as described above, the in-situ stress testing tool 10 may include a tool control system 22 (not shown) that controls the local functionality of the in-situ stress testing tool 10 and, in certain embodiments, the inflatable packers 36, as described in greater detail herein. In certain embodiments, the tool control system 22 of the in-situ stress testing tool 10 may communicate with the surface control system 18 such that the control systems 18, 22 collectively control operation of the in-situ stress testing tool 10 and/or the inflatable packers 36. As will be appreciated, the tool control system 22 of the in-situ stress testing tool 10 may include components that are substantially similar to the components of the surface control system 18 illustrated in FIG. 3, other than the display 72 and the input devices 74.

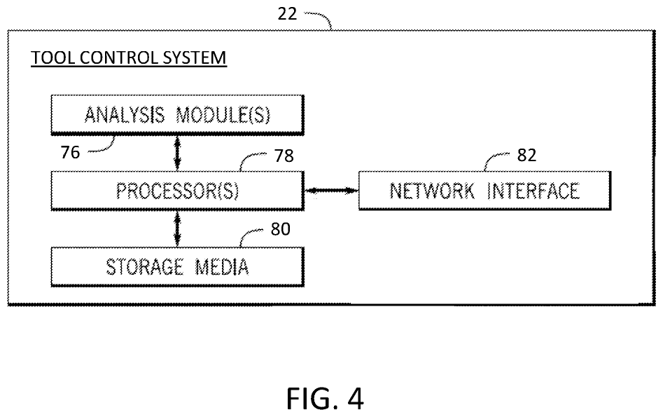

FIG. 4 illustrates an embodiment of the tool control system 22 illustrated in FIG. 1. In certain embodiments, the tool control system 22 may include one or more analysis modules 76 (e.g., a program of processor executable instructions and associated data) that may be configured to perform various functions of the embodiments described herein. In certain embodiments, to perform these various functions, an analysis module 76 executes on one or more processors 78 of the tool control system 22, which may be connected to one or more storage media 80 of the tool control system 22. Indeed, in certain embodiments, the one or more analysis modules 76 may be stored in the one or more storage media 80.

In certain embodiments, the one or more processors 78 may include a microprocessor, a microcontroller, a processor module or subsystem, a programmable integrated circuit, a programmable gate array, a digital signal processor (DSP), or another control or computing device. In certain embodiments, the one or more storage media 80 may be implemented as one or more non-transitory computer-readable or machine-readable storage media. In addition, in certain embodiments, the one or more storage media 80 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; or other types of storage devices. Such computer-readable or machine-readable storage medium or media are considered to be part of an article (or article of manufacture), which may refer to any manufactured single component or multiple components. In addition, in certain embodiments, the processor(s) 78 may be connected to a network interface 82 of the tool control system 22 to allow the tool control system 22 to communicate with the surface control system 18.

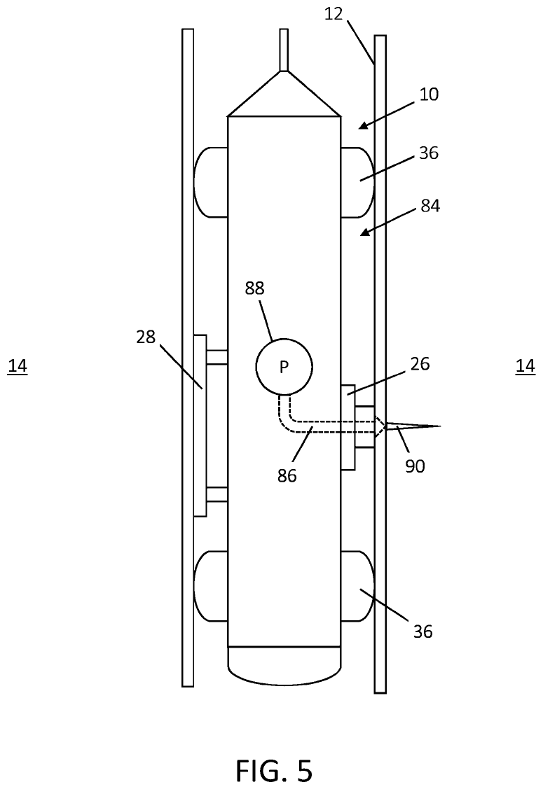

As described above, the embodiments described herein include an in-situ stress testing tool 10 configured to perform reservoir fluid analysis by drawing in formation fluid and testing the formation fluid downhole or collecting a sample of the formation fluid to bring to the surface. For example, in certain embodiments, the in-situ stress testing tool 10 may use the inflatable packers 36 to isolate a section (i.e., interval) 84 of the wellbore 12 (e.g., at a desired depth) and establish fluid communication with the subterranean formation 14 surrounding the wellbore 12. In particular, as illustrated in FIG. 5, the embodiments described herein relate to formation rock in-situ stress testing with an in-situ stress testing tool 10. In particular, for the formation rock in-situ stress testing, a dual packer system (e.g., using the inflatable packers 36) may be used to straddle the interval 84 of the wellbore 12, and the pressure in that interval 84 may be increased by injecting fluid 86 using a downhole pump 88 of the in-situ stress testing tool 10. The pressure then builds until the formation rock mechanically fails, creating a fracture 90 in the subterranean formation 14. After creation of the fracture 90 in the subterranean formation 14, additional fluid injection may propagate and enlarge the fracture 90 away from the wellbore 12.

When injection of the fluid 86 is stopped, the stresses in the formation rock will exert a closing force on the fracture 90. For closure of the fracture 90 to occur, at least some of the fluid 86 must exit the fracture 90. The fluid 86 may either leak-off into permeable rock or, if the rock is not permeable enough, the fluid 86 may be directed to flow back into the in-situ stress testing tool 10 (e.g., via constant choke flowback or constant rate flowback), or the closure pressure may be constrained by re-opening measurements or fracture rebounding techniques. The measured pressure in the dual packer interval 84 at moment of closure may be equal to the minimum horizontal stress in the subterranean formation 14. To measure the closure event and to infer the minimum horizontal stress is a main objective of the formation rock in-situ stress testing.

A large variation in tangential stress occurs along the wellbore 12 in the region of the in-situ stress testing tool 10 due to the differences in the hydrostatic pressure of the mud in the well, the pressure of the inflatable packers 36 contacting the wellbore 12, and the pressure in the interval 84 straddled by the inflatable packers 36. Above and below the straddled dual packers 36, the wellbore pressure normally remains under hydrostatic conditions throughout the testing, implying relatively high compressive hoop stresses in the near-wellbore environment. Inflating the packers 36 to ensure hydraulic isolation of the interval 84, however, results in a reduction of hoop stress state. As the fluid 86 is pumped into the interval 84 and the packer pressure increases, there is a further reduction in hoop stress towards a tensile stress state. A consequence of this hoop stress reduction is that a tensile tangential stress state may first be expected at the packers 36. Assuming a relatively uniform tensile strength distribution over the tested interval 84, the fracture initiation point should be at the depth of the packer 36 and not near the middle of the test interval 84 itself. However, since the fluid 86 is being pumped from inside the isolated interval 84, the fracture 90 may be propagated from this interval 84 straddled by the dual packer system of the inflatable packers 36.

Once the fracture 90 is created, additional fluid injection will propagate and enlarge the fracture 90 away from the wellbore 12. Ideally, the fracture 90 will be contained within the straddled interval 84 and will only propagate away from the wellbore 12. However, in reality, fracture growth may also continue behind the inflatable packers 36. Representative in-situ stress measurements may be obtained if the fracture closure, obtained either from leak-off or flowback, occurs in such a way that the fracture 90 closes freely at the sand face (i.e., the wellbore wall). Fractures 90 that have partially propagated behind the dual packers 36 may not close freely, and determining the closure pressure may be more difficult.

Furthermore, rock lithology variations, as well as rock stress variations along the tested interval 84 (i.e., behind the inflatable packers 36 and within the straddled interval 84 itself) may prevent the fracture 90 from growing within the straddled interval 84. In such situations, the fracture 90 may partially propagate behind the inflatable packers 36 to the extent that it becomes relatively difficult to acquire representative closure. On the other hand, variations of the mud hydrostatic pressure and packer pressure, as well as the difference between the packer pressure and the interval pressure (e.g., required to keep the seal between the inflatable packers 36 and the wellbore 12) may cause the fracture 90 to be locked mechanically open, and to prevent closure in the straddled interval 84.

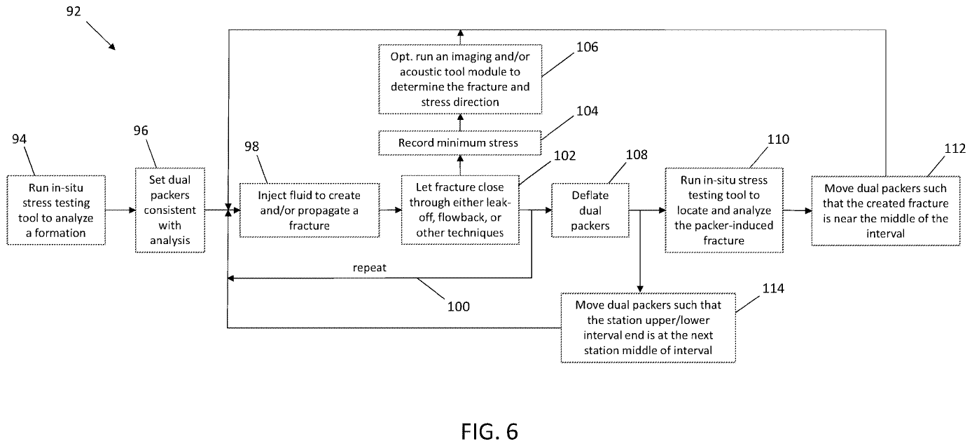

FIG. 6 illustrates an example workflow 92 to enable representative fracture closure measurements utilizing the in-situ stress testing tool 10 described herein. As illustrated, the workflow 92 may begin running the in-situ stress testing tool 10 into the wellbore 12 to analyze a target zone of the subterranean formation 14 with the imaging and/or acoustic tool module 38 of the in-situ stress testing tool 10 (step 94). For example, in certain embodiments, the analysis performed in step 94 may include, among other things: (1) mapping a pre-existing stress profile without any formation damage (e.g., breakouts, hole elongation, or drilling-induced fractures); (2) mapping homogenous isotropic intervals having favorable vertical length to set the dual inflatable packers 36; (3) mapping existing fractures (and their types), fracture networks, faults, and so forth; and (4) identifying clasts, nodules or formation damage (e.g., related to drilling or mud interaction). Then, the dual inflatable packers 36 may be set at a target depth consistent with the analysis performed in step 94 (step 96). For example, in certain embodiments, the dual inflatable packers 36 may be set at favorable intervals 84 that meet the conditions in points (1) and (2) of step 94 described above, while avoiding intervals 84 that fall under points (3) and (4) of step 94 described above. Then, fluid may be injected into the subterranean formation 14 to initiate, break-down, and create and/or propagate a fracture 90 using in-situ stress testing techniques, as described above (step 108). Then, several cycles 100 of fracture closure (e.g., via leak-off or flowback) and/or re-opening may be conducted.

During each cycle, minimum stress measurements may be recorded by the formation testing tool module 24 of the in-situ stress testing tool 10 (step 94). If repeatable fracture closure measurements are not obtained by the formation testing tool module 24 of the in-situ stress testing tool 10 during these cycles, this may indicate that the fracture 90 may not be fully contained within the straddled interval 84, or that a closure of the fracture 90 is difficult to obtain. In certain embodiments, the imaging and/or acoustic tool module 38 of the in-situ stress testing tool 10 may acquire image logs and/or acoustic logs, which may be combined with the information (i.e., data) collected by the formation testing tool module 24 of the in-situ stress testing tool 10 to locate the fracture 90 and/or to determine the direction of the fracture 90. Once measurements are collected by the formation testing tool module 24 of the in-situ stress testing tool 10 at the current depth, the dual inflatable packers 36 may be deflated (step 108) and moved shallower or deeper accordingly (i.e., based at least in part on the measurements) to the expected determined fracture location while continuously running the imaging and/or acoustic tool module 38 of the in-situ stress testing tool 10 to locate and analyze the packer-induced fracture 90 (step 110) until the packer-induced fracture 90 is near the middle of the new station interval 84 between the dual inflatable packers 36 (step 112). As used herein, the term “near the middle” of an interval 84 may be used to define a location along the interval 84 that is approximately halfway between upper and lower ends of the interval 84 (e.g., approximately 50% along the interval 84, approximately 45-55% along the interval 84, or approximately 40-60% along the interval 84, and so forth).

In certain situations where fracture closure cannot be obtained (i.e., is not observed by the leak-off, flowback, or other technique by the in-situ stress testing tool 10) and no other imaging/acoustic tools are available, it may be assumed that the fracture 90 has initiated at the upper inflatable packer 36 and the dual inflatable packers 36 may be moved such that the upper end of the current station interval 84 becomes the middle of the new station interval 84 (step 114). If fracture closure still cannot be obtained by the in-situ stress testing tool 10, the dual inflatable packers 36 may be moved such that the lower end of the current station interval 84 becomes the middle of the new station interval 84 (step 114).

As such, the workflow 92 illustrated in FIG. 6 conducts fracture reopening/growth/closure cycles to determine minimum horizontal stress. An alternative workflow may be implemented where a single packer is used to create micro-fractures in the wellbore wall (e.g., using sleeve fracturing techniques) by inflating a single packer element against the wellbore wall. Then, a dual-packer in-situ stress testing technique may be used to straddle those microfractures. The sleeve fracturing objective is to reduce subsequent hydraulic fracture breakdown pressure and to initiate that fracture 90 at the middle of the straddled interval 84. The workflow illustrated in FIG. 6 is different because it is not required to run or set a dedicated sleeve fracturing tool and, if fracture closure is measured on the first hydraulic fracture 90, then no further interval stations are required. However, if a fracture 90 is actually created on the first hydraulic attempts, but closure of the fracture 90 is not obtained, the workflow enables movement of the dual inflatable packers 36 to place the existing fracture in the middle of the interval 84.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method, comprising:
setting upper and lower packers of an in-situ stress testing tool at a target depth within a wellbore traversing a subterranean formation;
injecting fluid from the in-situ stress testing tool into the subterranean formation at a downhole location within a first interval between the upper and lower packers to create and/or propagate a fracture within the subterranean formation;
iteratively conducting a plurality of cycles of potential closure and/or re-opening of the fracture while injecting the fluid from the in-situ stress testing tool into the subterranean formation and recording minimum stress measurements of the subterranean formation; and
moving the upper and lower packers of the in-situ stress testing tool to a new depth within the wellbore while running an imaging and/or acoustic tool module of the in-situ stress testing tool to locate the fracture near a middle of a second interval between the upper and lower packers.

2. The method of claim 1, comprising:
when a closure of the fracture is either not observed by the in-situ stress testing tool during, or is observed and inconsistent between, the plurality of cycles of potential closure and/or re-opening of the fracture, moving the upper and lower packers of the in-situ stress testing tool to a new upper depth such that an upper end of the first interval between the upper and lower packers during the plurality of cycles of potential closure and/or re-opening of the fracture becomes the middle of the second interval between the upper and lower packers.

3. The method of claim 1, comprising:
when a closure of the fracture is either not observed by the in-situ stress testing tool during, or is observed and inconsistent between, the plurality of cycles of potential closure and/or re-opening of the fracture, moving the upper and lower packers of the in-situ stress testing tool to a new lower depth such that a lower end of the first interval between the upper and lower packers during the plurality of cycles of potential closure and/or re-opening of the fracture becomes the middle of the second interval between the upper and lower packers.

4. The method of claim 1, comprising combining data collected by a formation testing tool module of the in-situ stress testing tool and an imaging and/or acoustic tool module of the in-situ stress testing tool to locate the fracture and/or to determine a direction of the fracture, and to locate the fracture near the middle of the second interval between the upper and lower packers.

5. A formation testing system, comprising:
an in-situ stress testing tool comprising upper and lower packers; and
a control system configured to control operations of the in-situ stress testing tool, wherein the operations of the in-situ stress testing tool comprise:
setting the upper and lower packers at a target depth within a wellbore traversing a subterranean formation;
injecting fluid into the subterranean formation at a downhole location within a first interval between the upper and lower packers to create and/or propagate a fracture within the subterranean formation;
iteratively conducting a plurality of cycles of potential closure and/or re-opening of the fracture while injecting the fluid into the subterranean formation and recording minimum stress measurements of the subterranean formation; and
moving the upper and lower packers of the in-situ stress testing tool to a new depth within the wellbore while locating the fracture near a middle of a second interval between the upper and lower packers.

6. The formation testing system of claim 5, wherein the operations of the in-situ stress testing tool comprise:
when a closure of the fracture is either not observed during, or is observed and inconsistent between, the plurality of cycles of potential closure and/or re-opening of the fracture, moving the upper and lower packers to a new upper depth such that an upper end of the first interval between the upper and lower packers during the plurality of cycles of potential closure and/or re-opening of the fracture becomes the middle of the second interval between the upper and lower packers.

7. The formation testing system of claim 5, wherein the operations of the in-situ stress testing tool comprise:
when a closure of the fracture is either not observed during, or is observed and inconsistent between, the plurality of cycles of potential closure and/or re-opening of the fracture, moving the upper and lower packers to a new lower depth such that a lower end of the first interval between the upper and lower packers during the plurality of cycles of potential closure and/or re-opening of the fracture becomes the middle of the second interval between the upper and lower packers.

8. The formation testing system of claim 5, wherein the operations of the in-situ stress testing tool comprise combining data received from an imaging and/or acoustic tool module of the in-situ stress testing tool with data collected by a formation testing tool module of the in-situ stress testing tool to locate the fracture and/or to determine a direction of the fracture, and to locate the fracture near the middle of the second interval between the upper and lower packers.

9. The formation testing system of claim 5, wherein the control system comprises a tool control system of the in-situ stress testing tool.

10. The formation testing system of claim 5, wherein the control system comprises a surface control system located at a surface location relative to the wellbore.
